(19) United States
(12) Patent Application Publication
(10) Pub. No.: US 2009/0181135 A1
(43) Pub. Date: Jul. 16, 2009

(54) Dough and dough product packaging configurations

(76) Inventors: David J. Domingues, Plymouth, MN (US); Susan Hall, New Hope, MN (US); David A. Kirk, Coon Rapids, MN (US); Scott Kackman, New Hope, MN (US)

Correspondence Address: GENERAL MILLS, INC., P.O. BOX 1113, MINNEAPOLIS, MN, 55440, US

(21) Appl. No.: 12/319,597

(22) Filed: Jan. 9, 2009

Related U.S. Application Data
(60) Provisional application No. 61/010,876, filed on Jan. 11, 2008.

(51) Int. Cl. A21D 10/02

(52) U.S. Cl. 426/118; 426/128; 426/410; 426/395

(57) ABSTRACT

Described are dough products that include a packaged refrigerator-stable, raw, dough compositions, and related methods, including but not limited to dough products that include a package having specific venting, specific opening mechanisms, and other specific package structures.

### REFERENCE TO RELATED APPLICATIONS

This application claims the benefit of priority under 35 U.S.C. 119(e)(1) of a provisional patent application, Ser. No. 61/010,876, filed Jan. 11, 2008, which is incorporated herein by reference in its entirety.

### FIELD OF THE INVENTION

The invention relates to dough products that include a packaged refrigerator-stable, raw, dough compositions, and related methods.

### BACKGROUND

Many dough products are prepared commercially to be sold as packaged, refrigerator-stable or freezer-stable products. Refrigerated dough products can be stored at refrigerator conditions and cooked (e.g., baked) by removing the packaged dough from refrigerated storage and cooking the dough with little or no additional preparation. Frozen dough products can be stored at freezer conditions and cooked (e.g., baked) by removing the packaged dough from refrigerated storage, optionally but not necessarily thawing, and cooking. Both refrigerated and frozen dough products can be very desirable to consumers because of their convenience.

A variety of dough products are sold commercially as being refrigerator or freezer stable. Examples include doughs sometimes referred to in the baking arts as “undeveloped doughs” such as cookies, cakes, biscuits, scones, and batters; other examples are “developed” doughs such as breads and bread-like products including French bread, white or whole wheat bread, bread sticks, bread rolls, pizza dough, cinnamon rolls, raised donuts, and other products having developed dough properties.

Developed doughs are prepared to leaven and increase the size and decrease the density of the cooked (e.g., baked) dough product. This can be done by the action of yeast or by the action of chemical ingredients (“chemical leavening agents”) that react to produce a leavening gas. Leavening can take place either before or during baking. Many refrigerated or frozen dough products include chemical leavening agents, and are allowed to proof before they are packaged, during storage, or during baking.

An important component of a refrigerated or frozen dough product can be its packaging configuration and packaging materials. Preferred packaging materials and designs can contribute to retaining freshness over an extended period of storage. Many types of packaging materials and package forms are used commercially, including pressurized cans and non-pressurized pouches or chubs.

Packaged raw dough products continue to exhibit limited storage lives. A packaged dough, during extended storage, may, for example, experience deteriorated freshness in the form of discoloration or loss of leavening properties upon baking. It is a continuing goal in the packaged food arts to improve the storage life of dough products.

### SUMMARY

The invention described herein relates to various features of packaging materials and package designs useful for refrigerated or frozen dough products. The dough product contained in the package can be any of a wide variety of dough products that can be used by a consumer to “home bake” a dough to produce a desirable hot, fresh-baked item. Many such items are proofed prior to baking, and for consumer convenience may be partially or fully proofed prior to purchase and prior to use by the end consumer. Such products, sold after proofing or partial proofing, are examples of products referred to as “pre-proofed.” Examples of pre-proofed dough products include breads and bread-like products that generally contain a leavening ingredient and include but are not limited to loaves of bread such as French bread, white or whole wheat bread, bread sticks, biscuits (i.e., “soda biscuits”), rolls, pizza dough, croissants, sweet rolls such as cinnamon roll that includes an icing for application after the sweet roll is baked, other dough products that can include a dough and a non-dough component such as a sauce (e.g., tomato sauce), cheese sauce, cheese, fruit compote, and the like.

One technique for preparing a pre-proofed dough product for sale is by use of a package having a fixed volume and venting, and allowing a contained dough composition to proof and expand inside of the packaging and seal the container from inside, e.g., self-sealing packages such as wound paperboard or paperboard canisters. Such products include dough formulations that can be, but are not necessarily, chemically-leavenable.

For example, one method of accommodating proofing of a chemically-leavenable dough composition during or prior to refrigerated storage is to place an unproofed dough composition in a fixed-volume package. The dough is allowed to proof or partially proof inside of the package. With expansion of the dough composition, the dough volume increases to fill the entire package volume, and upon further expansion may increase the pressure inside the canister (if desired). The package can be, for example, a wound canister formed from composite paperboard and spirally wound into a cylinder. The initial volume of dough packed into the canister can be less than or equal to the canister volume and as the dough proofs, gas is expelled through venting. Once the dough reaches the approximate volume of the canister, the pressure increases to force the dough against canister end caps to seal gas passages around the end caps of the canister.

There is continuing need for new types of packaged pre-proofed dough products that may be refrigerator stable for multiple weeks of refrigerated storage. Similarly, there is continuing need for new methods of packaging and preparing such packaged dough products. Particularly useful and economical packages are those that are simple and durable, such as flexible film packaging with no pressure release valve.

The following description identifies packaging configurations that include two opposing films, e.g., polymeric films, used to produce a package that contains raw dough, optionally multiple pieces of raw dough. The two opposing films contain dough between opposing surfaces of the films and the films are closed by sealing around a perimeter to form the package. “Closed” and “sealed” refer to sealing methods as described, which also allow for a vent to be placed at a sealed portion of two opposing films, such as a microvent or a vent that includes a tortuous path.

According to certain embodiments of these packaging configurations, each of the two opposing “films” can be part of a single piece of film, folded at one edge. The two “films” are actually different portions or sections of a single integral piece of film connected (integrally) at a folded edge, and contacting each other at additional surfaces or edges in a manner to cause opposing surfaces of the different “film” sections to create an internal package space. Alternately, each of the two opposing films can be separate pieces of films brought together to contain dough. The two films may be of the same or of different composition. Also alternately or additionally, for any two types of films (whether a single, folded piece or two or more separate pieces), one or both of two films can include a three-dimensional cavity formed to contain a dough or a non-dough composition. A three-dimensional cavity can be formed by thermoforming or molding a flat film to produce a non-flat, three-dimensional film.

Certain aspects of the invention relate to dough packages that include various designs and constructions for allowing a dough to expand and proof or pre-proof within a package suitable for refrigerated storage. Other doughs may be packaged in a pre-proofed condition, or may be proofed after removal from the package. The package may be of a fixed volume or a variable volume and may include creative design features to allow gas to be expelled from the package. The packages generally may be in the form of any of a chub, cylinder (e.g., can or canister), flowrap package, horizontal form fill sealed package, vertical form fill sealed package, a pouch, etc., and some of the inventive 1 5 packages can be pressurized (e.g., of an internal pressure of 15 psig or greater) or of a low package pressure (e.g., having an internal pressure of less than 15 psig, preferably from 0 to 10 psig, e.g., 0 to 5 psig) during refrigerated or frozen storage, e.g., after placement of a dough inside of the container and optional expansion of the dough within the container. Packages as described herein can be particularly useful with low pressure 20 dough product configurations. The package may be rigid, semi-rigid, flexible, or a combination of these.

A package may include an opening mechanism that can include a pull strip, endcaps, an adhesive seal, perforations, or a breakable or delaminatable multi-layer, or a scored, or die-cut (e.g., reverse-cut) opening mechanism. One particular type of elongate 25 package may be a cylindrical or other shaped tube (e.g., square, rectangular, triangular), with two endcaps, one at each end. Endcaps may be removable or otherwise openable to allow the package to be opened, or, the package may be opened by disassembling the tube, such as by unwinding a wound tube. Alternately, a package can exclude endcaps and can be sealed by alternate sealing mechanisms such as adhesive sealing, mechanical 30 sealing, heat sealing, thermoforming, thermosealing, and the like.

Packages as described herein include dough product packages that may include materials that are flexible, rigid, or semi-rigid, for ends or sides of a package. Gases such as carbon dioxide, oxygen, or an inert gas (e.g., from flushing) may be present at the package interior due to packaging and processing history or due to proofing of the packaged dough composition and attendant production of carbon dioxide by a dough leavening system. A dough may also produce carbon dioxide and experience expansion within the package by proofing or partial proofing after being inserted into the package. Any gas that is present in the interior space of the package during dough expansion may be desirably expelled from the package as the dough expands into the internal volume of the package. Various modes are described for allowing gas to be expelled from a package.

The package sides and ends can be of flexible, rigid, or semi-rigid packaging material, or a combination of these, and may include layers or materials that are selectively permeable or impermeable to gases such as oxygen, carbon dioxide, water vapor, etc. Exemplary flexible materials include flexible polymeric films including those that are presently known or that may be developed in the future for use in packaging dough compositions, including materials that are any one or more of thermoformable, gas (e.g., CO₂, O₂, water vapor) permeable or gas impermeable, multi-layer, coated (e.g., metallized), and may include a sealing layer, an adhesive layer, one or multiple barrier layers, a film particulate matrix layer of high porosity, etc.

The dough composition can be any type of leavenable dough composition, e.g., a proofed or unproofed dough composition that is storage-stable at refrigerated storage temperature. The dough composition can be leavenable by action of yeast or chemical leavening agents. Examples of useful types of dough compositions include chemically-leavenable biscuits (“soda” biscuits), breads, and bread-like dough compositions including French bread, bread rolls, croissants, sweet rolls, cinnamon roll (including a frosting), pizza crust.

Certain embodiments of the invention include a pre-proofed dough composition packaged in a low pressure flexible package, optionally and preferably with little or no headspace. A low pressure package can mean a package that is substantially air tight, with an internal pressure that is typically less than 15 psig (pounds per square inch, gauge) (gauge pressure is absolute pressure minus atmospheric pressure, i.e., “psig” refers to “psi absolute,” minus approximately 1 atmosphere or 14.7 psi; for example a gauge pressure of 0 psig inside a package is a pressure of approximately 1 atmosphere or 14.7 psi absolute). Examples of low pressure packages can be any of a canister, chub, pouches, flowrap package, horizontal form fill sealed package, etc., that does not exhibit a pressurized (greater than 15 psig) interior. A dislike of some consumers with the use of certain current pressurized refrigerator-stable dough products is that pressurized packages can pop when opened. Advantageously, embodiments of packages described herein, which include a low pressure packaging system, can avoid this popping, because the internal pressure does not build to the same levels of the current consumer products that do pop when opened.

Methods of the invention can involve placing unproofed dough into a package that is designed to allow the dough to expand while proofing or partially proofing inside of the package. The package may optionally be flushed with carbon dioxide, or an inert gas such as nitrogen, during a step of placing the dough into a package. The dough, within the package, can increase in size by expansion due to a leavening agent, to take up interior space of the package. The package can be either of a fixed volume or a variable volume. A fixed volume package may include venting that allows gases inside of the package to be expelled. In other embodiments, a variable-volume package may expand to increase in volume as the dough inside of the package also expands. With either a fixed or a variable volume package, the dough can expand and the final pressure of the dough can depend on the amount of expansion of the dough relative to the fixed or expanded volume of the package. A package, upon expansion of the dough, may be pressurized (e.g., have an internal pressure of 15 psig or more) or may be at a low pressure (e.g., have an ambient internal pressure (0 psig, 1 atm) or a pressure in the range from 0 psig to 10 psig, e.g., from 3 psig to 8 psig).

In certain embodiments the package containing the expanded dough can include limited headspace, preferably very little or no headspace. “Headspace” refers to the internal volume within a package that is not taken up by dough composition; i.e., the internal volume as packaged not including the dough product. The headspace of a packaged dough composition described herein can be, e.g., less than about 20 percent (dough cans) of the total internal volume of the packaged product, such as, less than 3 percent of the total internal package volume.

Exemplary packaged dough products of the invention can be designed to produce a packaged product of a dough with a desired raw specific volume as measured inside the package (e.g., from 1.2 to 2.0 cc/gram), and a package having an internal pressure within a desired range (e.g., 0 to 15 psig).

Certain embodiments of products described herein allow for a dough composition to expand, e.g., proof or partially proof, inside of a package. This advantageously reduces steps of handling the dough composition that would otherwise be required if the dough composition were first proofed or partially proofed outside of the package, and then placed into a package in an expanded condition. Additionally, proofing or partially proofing after packaging may reduce or eliminate potential contamination of a dough product.

In different embodiments, a dough may be packaged and stored at refrigerated or frozen conditions, proofed or unproofed. A dough may for example be packaged in an unproofed condition and refrigerated or frozen, with the dough proofing during refrigerated storage following packaging. Alternately, a dough may be packaged in an unproofed condition, then stored at refrigerated or frozen conditions while unproofed; the dough may be stored and optionally shipped and sold in the unproofed frozen state, then proofed outside of the package.

As used in the present description, “proof” and “proofing” relate to a step before baking of a dough composition that allows at least partial expansion (i.e., at least partial proofing) of a dough composition by giving time to allow yeast or chemical leavening agents to produce leavening gas that forms bubbles within the dough composition and thereby expands the dough composition to a desired volume.

“Pre-proofed” means that a dough product does not require a proofing step after removal from refrigerated or frozen storage, prior to cooking, e.g., baking.

The term “unproofed” is used as generally understood in the dough and baking arts, e.g., to refer to a dough composition that has not been processed to include timing intended to cause or allow proofing or intentional leavening of a dough composition. For example, a dough composition may not have been subjected to a specific holding stage for causing the volume of the dough to increase by 10% or more.

In a general aspect, the invention relates to packaged dough products that include two opposing films. The films contain dough between opposing surfaces of the films and the films are sealed around a at least a portion of the perimeter of the package.

In a different aspect, the invention relates to methods of packaging a dough within a package that contains two films. The methods include: providing a first film surface, placing raw dough in contact with the first film surface, providing a second film surface, placing the second film surface in contact with the raw dough, and closing the package by sealing edges of the films.

In yet another aspect, the invention relates to packaged dough products that includes a film package. The film package includes a piece of film folded to produce a folded edge, an opposite edge opposite of the folded edge, a first end between the folded edge and the opposite edge, and a second end between the folded edge and the opposite edge. The package is sealed at the opposite edge and at the ends.

In another aspect the invention relates to methods of packaging a dough product in a flowrap package. The methods include: providing a film, folding the film to produce a package form comprising a folded edge, an opposite edge opposite of the folded edge, a first end between the folded edge and the opposite edge, and a second end between the folded edge and the opposite edge, placing dough at the film, and sealing the film along the opposite edge and at the two ends.

In yet another aspect the invention relates to a packaged dough product that includes a form fill sealed package. The form fill sealed package includes two films, a first film that includes a three-dimensional cavity containing dough, and a film covering the cavity.

In another aspect, the invention relates to a method of packaging a dough product in a form fill sealed package. The method includes: providing a film comprising a three-dimensional cavity, placing raw dough in the cavity, and sealing the cavity by placing a film over the cavity.

In another aspect the invention relates to a packaged dough product that includes a package that includes a tortuous path that allows pressure of the package to equalize through the channel, but that prevents contaminants from passing into an internal portion of the container.

In yet another aspect the invention relates to a packaged dough product that includes a multi-layer film. A package opening mechanism includes partial cuts on opposite sides of the multi-layer film. Each partial cut penetrates one or multiple layers of the film but does not penetrate the film entirely.

### BRIEF DESCRIPTION OF THE DRAWINGS

FIG. 1 identifies various features of packaged dough products.

FIG. 1A illustrates a chub.

FIG. 2 identifies various features of packaged dough products that include a flowrap package.

FIGS. 2A, 2A(i), 2B, 2C, and 2D illustrate embodiments of flowrap package designs.

FIG. 3 identifies various features of packaged dough products that include a horizontal form fill sealed (“HFFS”) package.

FIGS. 3A through 3E(ii) illustrate embodiments of horizontal form fill sealed package designs.

FIGS. 4A and 4B illustrate embodiments of tortuous path vents.

FIGS. 5, 5A, and 5B illustrate an embodiment of a packaged dough product.

FIGS. 6A and 6B illustrate an embodiment of an opening mechanism.

FIGS. 7A and 7B illustrate an embodiment of a packaged dough product.

FIG. 8 illustrates an embodiment of a packaged dough product.

FIG. 9 illustrates an embodiment of a packaged dough product.

FIGS. 10A, 10B, and 10C illustrate an embodiment of a packaged dough product.

FIGS. 11A and 11B illustrate an embodiment of a packaged dough product.

The figures are schematic and not necessarily to scale.

### DETAILED DESCRIPTION

The following description identifies packaging configurations that include two opposing films, e.g., polymeric films, used to produce a package that contains raw dough, optionally multiple pieces of raw dough. The two opposing films contain dough between opposing surfaces of the films and the films are closed by sealing around at least a portion of a perimeter to form the package. One embodiment of a package for use with doughs and dough products described herein, independently or in combination with any one or more other feature described herein, is a package that is formed by a “flowrap” method. A “flowrap”-type package is a package formed by a flexible film material that is bent or folded from a single piece of packaging film material, and sealed at one or more edges (e.g., three edges) to form a sealed package. Flowrap packages are sometimes referred to as a “flow wrapper,” or a form fill wrappers. As one specific example, a flowrap package can be formed from a single film that is folded lengthwise (e.g., continuously) and sealed at length-wise edges opposite of the fold, to produce a tube. Dough or a dough product (e.g., dough and a separate container of frosting) can be placed inside of the tube, and the ends of the tube can be sealed. The filling can occur continuously and concurrently with cutting and sealing of ends or other edges of the container. Or the container can be formed (e.g., cut), one end can be sealed, and then filled, then the other end can be sealed. The package can include one or multiple pieces of dough, in a vertical or a horizontally stacked configuration.

This “flowrap” type package can be made from any material that can be formed and sealed as described, such as a plastic sheet material, paper, cardboard, paperboard, laminate, multi-layer plastic materials, etc. The sealing can be performed by any useful method, such as by adhesive, thermoplastic, or mechanical means. The package can be vented by any desired or useful venting technique (valve, vents, microvents, channels, tortuous path venting, etc.). The package can include any form of opening mechanism. As discussed elsewhere in this description, the package can be used to contain a refrigerated dough or dough product that is proofed, unproofed, refrigerated, etc., for any type of dough product, and may optionally include a separate container for a non-dough component of the dough product such as icing or frosting.

Other embodiments of packaged dough products as described herein, relating to a package having two opposing films, include “horizontal form fill sealed” package, such as a pouch-type packages that involve two opposing films: a “bottom” film includes a three-dimensionally formed cavity for placement of a dough or a dough product, optionally in the form of one or multiple pieces, and optionally including a separate package of non-dough material; and a “top” film that covers the bottom film to enclose the cavity and its contents. Examples of pouches are described in U.S. patent application Ser. Nos. 60/707,808; 29/297,836; 29/204,662; and in PCT/US07/73200; the entireties of each of these being incorporated herein by reference. According to the present description, a package such as any of those described or illustrated can include multiple cavities, and each cavity may include one or multiple dough pieces, or optional non-dough component. The dough pieces can be stacked or oriented in various configurations, including “horizontally” (generally aligned with the films) or “vertically” (generally perpendicular to the films), including vertically at an angle that is not perpendicular to the films. The package can be sealed by any useful method, such as by adhesive, thermoplastic, or mechanical means. The package can be vented by any desired or useful venting technique (valve, vents, tortuous path venting, channel venting, microvents, etc.). The package can include any form of opening mechanism. As discussed elsewhere in this description, the package (e.g., one or more cavity) can contain a refrigerated dough or dough product that is proofed, unproofed, refrigerated, etc., for any type of dough product, and may optionally include a separate container for a non-dough component of the dough product such as icing or frosting.

Any of the packages described herein can be vented or non-vented, as desired. A venting mechanism can be any type of venting mechanism that is known, including a valve, one-way valve, or a channel located at a lid of a self-sealing canister. A vent may also be a microvent, such as a laser perforation or a channel having small dimensions, as described in PCT/US07/73200, filed Jul. 11, 2007, the entirety of the disclosure being incorporated herein by reference.

In other embodiments a vent may be in the form of a tortuous path. A tortuous path vent can be a vent in a package that includes an opening at the internal side of the package and a channel leading to an external opening. (Alternately, the package can include a film particulate matrix layer of high porosity.) A tortuous path vent can include a channel having corners, twists, or turns, that functionally allow pressure at the interior of the package to equalize through the channel, but that can also prevent contaminants from passing into the internal portion of the container through the vent. Also in a functional sense, a tortuous path vent can allow gas to be expelled from a package interior upon expansion of a dough within the package, to allow the expanding dough to fill the internal package volume, optionally to eliminate headspace gas present within the package prior to dough expansion. The expanded dough can contact the internal opening of a tortuous path on the interior side of the package to seal the tortuous path vent from the inside of the package and substantially prevent further passage of gases through the tortuous path vents, either into or out of the package interior. Further proofing and expansion of the dough within the package may cause the dough to produce an increased pressure within the interior space of the package.

A tortuous path vent may be located at a location on a package that has a length dimension extending from the package, such as at a seam, flap, flange, etc. The dimensions of a tortuous path channel can be, e.g., 100 to 400 microns (or micrometer, μm) in diameter, and a length that extends through a seam with multiple twists or turns, e.g., 2 to 5 times the width of the seam.

Alternately dimensions of a useful tortuous path can include the following: a useful diameter of a channel can be, e.g., in the range from 0.2 to 0.6 millimeter; useful length of a channel can be, e.g., from 2 to 20 millimeters; and a generally useful channel length can be at least ten times the diameter of the channel. Diameter can be calculated as an average diameter and length can be a length of a channel including any turns and corners, as opposed to a length that a channel traverses across a seam of a package (simply the dimension of the seam).

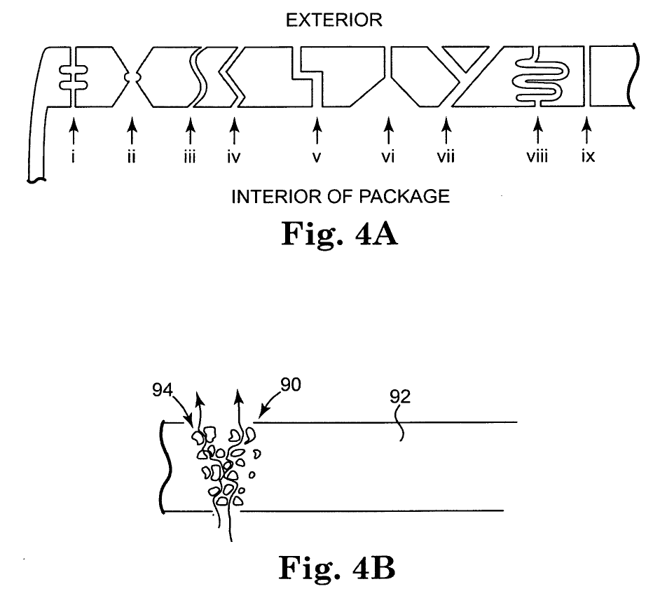

FIG. 4A shows examples of tortuous path vents that, as illustrated, are placed at a seam that is made by adhering two sheets of material together. FIG. 4A and all other figures are schematic and are not necessarily to scale. FIG. 4A shows tortuous path vent embodiments (i through ix) that extend from an opening at an interior of a dough package, through a two-layer seam, to an external opening. The path of the vent is not straight but includes at least one corner, twist, turn, or reservoir (i.e., a widened portion). Each path functions to allow pressure equalization across the seam, preferably without allowing contaminants to pass.

FIG. 4B shows an alternate example of what may be considered a tortuous path vent (90), in the form of a packaging material (92) (e.g., film) that includes a particulate matrix layer or portion of high porosity (94). This type of tortuous path vent does not include a discrete channel. But, like a channel of a tortuous path, the matrix causes fluid (air) or particulates to flow through a path that would include corners, twists, bends, or turns, that functionally allow pressure at the interior of the package to equalize through matrix, but that can also prevent contaminants from passing into the internal portion of the container through the matrix. Also in a functional sense, a matrix layer of high porosity can allow gas to be expelled from a package interior upon expansion of a dough within the package, to allow the expanding dough to fill the internal package volume, optionally to eliminate headspace gas present within the package prior to dough expansion.

A particulate matrix can include particulates of various composition and size, including particulate materials sometimes referred to as film fillers. To produce a matriculate matrix that functions as a tortuous path, the filler can be included in a film material, and the film material can be removed from a portion of the film layer to produce a tortuous path. Exemplary film fillers include insoluble, inert mineral material particles such as calcium carbonate (CaCO3), silica, diametaceaus earth, etc., as well as food fiber materials such as corn fiber, wheat fiber, etc., placed within a film layer. An aperture can be produced in the film layer to produce a layer that includes the film filler, packed together closely enough to produce one or multiple “tortuous” path passages across the film layer. For example, a volatile liquid such as ethanol, (or a similar organic liquid) could be used to remove polymeric material of a film in an applied area to create a tortuous path channel that includes the filler material, across the thickness of the film. Alternately or additionally, the film containing the filler could be stretched to create tortuous path. Ideal venting sizes would range from 100-400 micrometers, but tortuous path channels will not have a constant diameter or size throughout the channel.

According to different aspects of the invention, useful separately or in combination with any of the dough product and packaging designs described herein, a package for use with a dough product (i.e., any sort of package, without limitation) can also include a separate container for a non-dough component of a dough product. The non-dough component can be a liquid or a solid, such as a fluid, crystal, powder, etc. The non-dough component may be, for example, an icing, frosting, topping, sauce (e.g., tomato sauce), cheese, cheese sauce, salt, flour, or other food ingredient, butter, oil, shortening, sugar, spice, high fructose corn syrup, or the like, which may be a liquid, solid, flowable, non-flowable, powder, a combination of liquid and particulate, other combinations of these, etc. In specific embodiments, a non-dough component package can be included in a pressurized or low pressure package, in a chub, pouch, can, flowrap-type package (e.g., vertical flowrapper package), horizontal form-fill seal package, vertical form-fill seal package canister, can, etc., any of which may be vented or non-vented, flexible, rigid, etc. The second package for the non-dough component may be a small flexible envelope that fits between the dough and the a side of the container, or may be placed within a rolled dough piece, or may be in the size and shape of a dough piece such as a shape of a biscuit, roll, sheet, or puck.

A package for a non-dough component may be included internally on the primary package (chub, can, pouch, vertical flowrapper package, horizontal form-fill seal package, etc.), or the package for a non-dough component may be secured or attached at an external location. The material of the package can be any useful material and may be rigid, semi-rigid, or flexible.

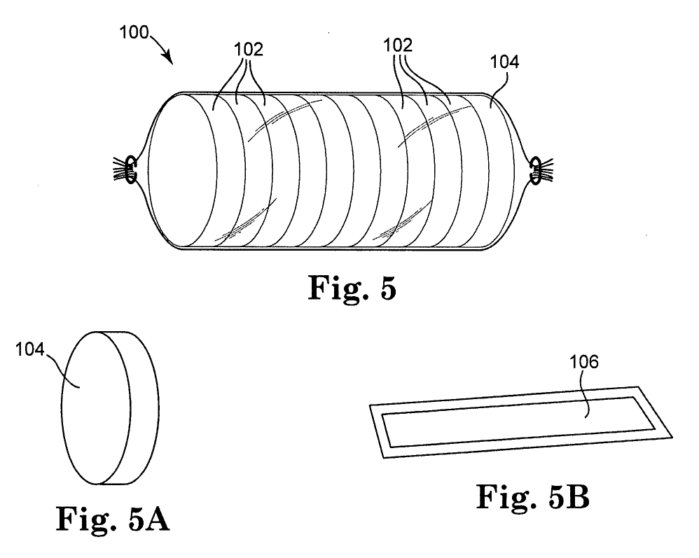

FIG. 5 shows a single example of packaged dough products that can include a package that contains dough and a separate internal package for a non-dough component of the dough product. FIG. 5 illustrates a flexible chub (100) that includes multiple dough pieces (102). A separate package (104) in the form of a dough-piece shaped puck shown at FIG. 5A can be included in place of a dough piece (see FIG. 5). Alternately, a pouch or envelope (106) can be included between the dough pieces and the package, such as the envelope (106) of FIG. 5B.

Another embodiment of a dough product relates to a package that includes an opening mechanism that functions by delamination, sometimes referred to as a “delamination seal.” Multi-layer packaging materials that can be separated by delamination are described, for example, at U.S. Pat. No. 6,306,472, incorporated herein by reference.

Specific embodiments of opening mechanisms that function by delamination of a multi-layer film can be prepared by a multi-layer flexible material, the opening feature being created by partially cutting or scoring one or more of the multiple layers of the flexible material (without cutting through all layers), on two different sides, allowing the film to be selectively delaminated (between the cutting or scoring) to open a panel or portion of the package. For example, one layer of a multi-layer flexible material may be cut on one surface, and a layer of the film may be cut on the opposite (second) surface, at a different location but near the first cut on the opposite side; neither cut penetrates the entire film. Pressure can be applied to the film at the location between the cuts and the film can delaminate at the area between the cuts, causing a separation of the film at that area that allows the film to be separated into two pieces.

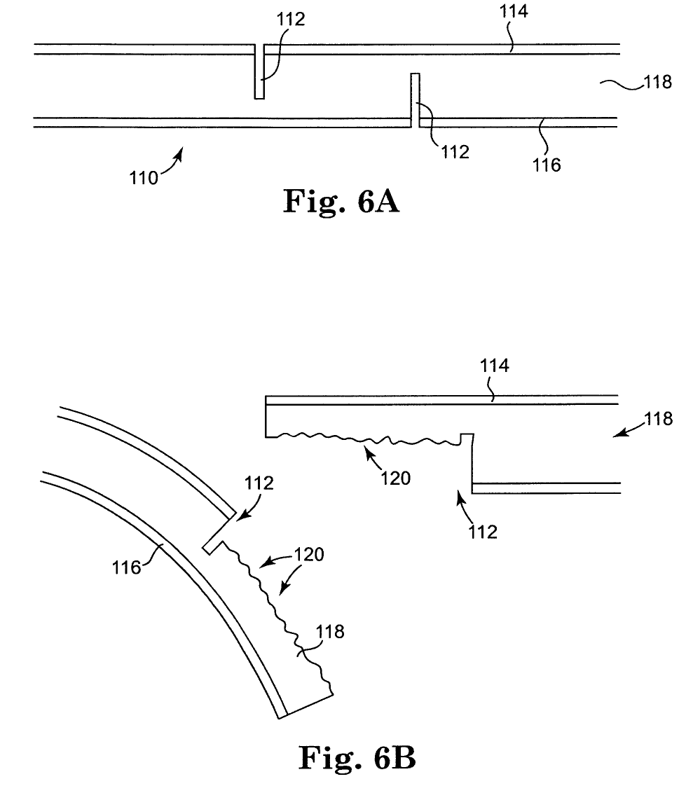

FIG. 6A shows a side view of a flexible multilayer packaging material (110) having cuts or scores (112) at two different locations on opposite surfaces. Cuts or scores 112 may be continuous or non-continuous, e.g., be perforations, and can be created in a layer of packaging material by cutting using any cutting technique. Packaging material 110 is illustrated to include three layers, two exterior layers (114, 116) and an interior layer 118. Each cut penetrates an exterior layer and extends partially into the interior layer. The cuts can be prepared by “reverse cut” or “die cutting” methods. As shown at FIGS. 6A and 6B, placement of the cuts on opposite surfaces of the film, at locations somewhat near each other and parallel to each other, allows for delamination of one or more middle layers (118) of the film between the opposing cuts in a manner that partially delaminates (at area 120, between cuts 112) the film (110) to open the package. The opening can be a strip, panel, flap, or any other disruption in the film and may be resealable, but need not be resealable.

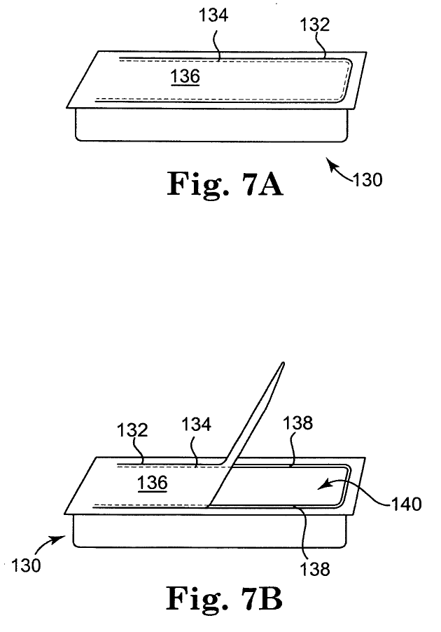

FIGS. 7A and 7B show a package configuration (130) that includes this type of multi-layer, partially delaminatable opening mechanism, such as is illustrated at FIGS. 6A and 6B. An outside (external) score line (132) (solid) is shown at an external surface (136) of a multi-layer film (e.g., as shown at FIGS. 6A and 6B). An inside (interior) score line (134) (dashed) is at the interior side of the film. When pressure is applied at the area of the package between the external and internal score lines, in a direction away from (alternately, toward) the package, an internal layer of the film between these two score lines can become delaminated or fractured to allow the film to be delaminated and separated between the outside score line and the inside score line. Area of delamination 138, and opening 140, result.

The packages and products described can include packaging graphics, ingredient listings, baking instructions, etc., at any orientation. Advantageously, embodiments of the described packaging configurations can include one or multiple printable (e.g., flat, rounded, curved, or otherwise) surfaces that will allow the packaged product to stand up, and the surface can allow the packaged product to be stood up and displayed in any desired orientation. For example, graphics and writing can be applied to the package to allow any of one or more flat surfaces to be used as a bottom, side, top, or front, when the package is displayed for purchase.

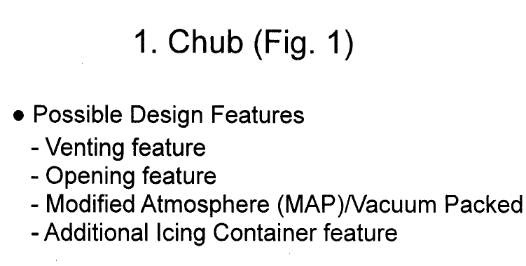

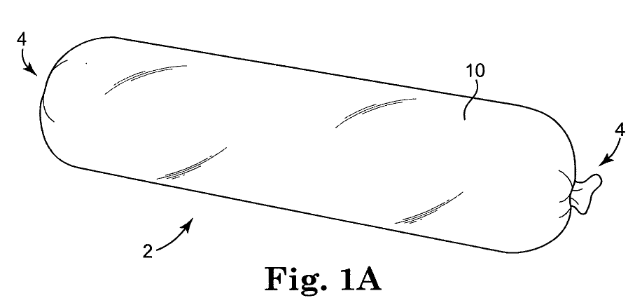

Referring now to FIG. 1, this shows a list of different, general, design features for use with packages and packaged doughs and packaged dough products described herein, such as for use with a chub shown at FIG. 1. A venting feature means that any of the package and product configurations can include a vent, which may be a valve, a microvent, a crimped end of a chub, a tortuous path, etc. An opening feature, which may be optional, can be a standard opening device, such as a tear strip, a pull strip, a perforation, etc., or may be a multi-layer delaminatable scored (e.g., reverse cut) opening mechanism. A package can include any form of atmosphere, such as a modified atmosphere package (MAP) of carbon dioxide or nitrogen, or vacuum packaging to eliminate (or expel) headspace, e.g., to a targeted or specified amount. Any of the package designs can contain one or multiple dough pieces and may optionally include one or multiple separate container or containers for a non-dough component of the dough product such as icing or frosting.

FIG. 1A shows a chub package (2) that includes a plastic tube (10) with crimped ends (4) that provide venting. The package can contain a dough (not shown) that is unproofed, or that has been proofed or partially proofed to fill the internal space of the package. Not shown, but optionally contained in the chub, may be a smaller package that contains a non-dough ingredient such as a refrigerated frosting, topping, sauce, etc., that can be applied to the dough product before or after the dough product is baked. The dough may be one or multiple pieces and may be stacked vertically as shown in FIG. 5. A second package for a non-dough component may be included, as shown at FIGS. 5A and 5B. The package can be stored by refrigeration with the package interior being at low pressure (0 to 15 psig) or at approximately ambient pressure (0 psig), and can maintain a pressure in that range for at least two weeks of refrigerated storage.

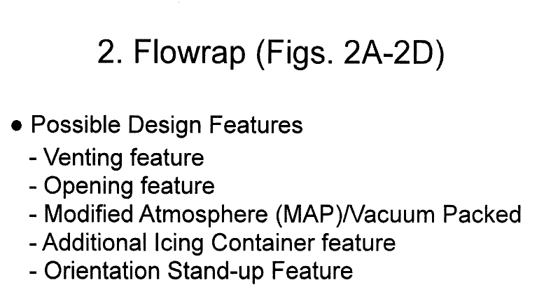

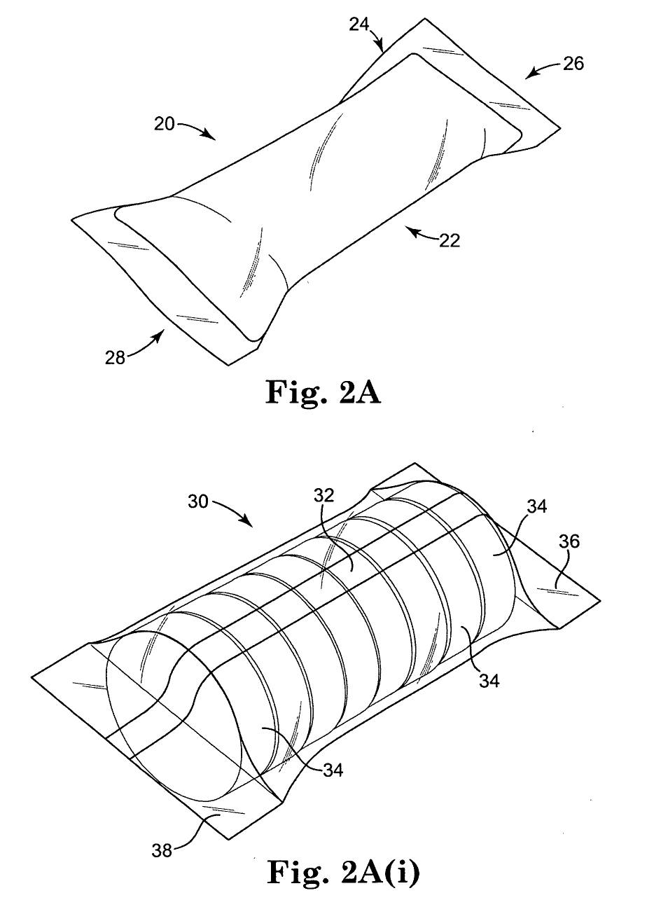

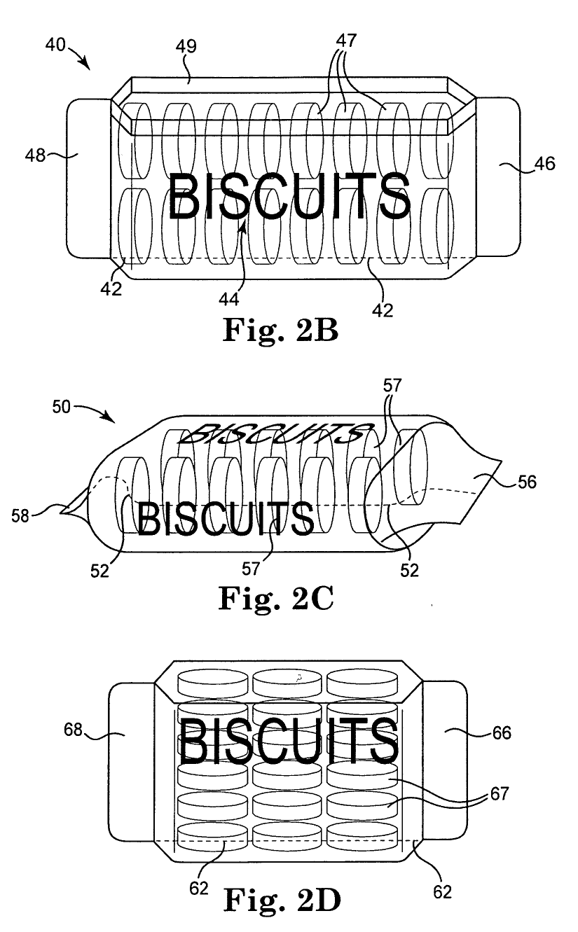

FIG. 2 generally describes that the features discussed herein can be applied to a “flowrap” type package.

FIGS. 2A, 2B, 2C, and 2D illustrate flowrap-type packages. FIG. 2A shows a clear plastic tube (20) formed by folding a film, and cutting and sealing three sides to form an “envelope” that is filled with a dough product. Package 20 includes folded edge 22, opposite edge 24, and two ends 26 and 28 located between the folded edge and the opposite edge. A single piece of dough (as illustrated) can be contained in the package.

FIG. 2A(i), shows a variation of this type of package that includes multiple dough pieces (34) in a horizontally-stacked configuration. Package 30 includes a folded edge on the bottom side of the package (not shown), opposite edge (seam) 34, and two ends 36 and 38 located between the folded edge and the opposite edge. As with plastic tube 20, the edge and ends may be sealed by any useful sealing method, such as thermosealing, adhesive, etc.

FIG. 2B shows a flowrap package (40) that includes a flat surface (44) that allows product information to be displayed on a front with a horizontal orientation. Package 40 of FIG. 2B can be formed by folding a single sheet of packaging material to form a tube, then bonding the edges to form bottom seam 42 at the bottom (not shown). The film can be cut and bonded to form each end (46, 48) (before or during placement of dough pieces inside of the package). Crimps (or “gussets”) (49) can be formed by folding the packaging material against itself and bonding at the fold, to produce a reinforcement (or “expansion”). Dough pieces 47 are shown in a multi-row, horizontally-stacked configuration.

FIGS. 2C and 2D show two more flowrap package configurations formed by folding a single sheet of packaging material to form a “tube” and sealing at the bottom (dashed line). Ends can be formed as described at FIG. 2b.

Package 50 of FIG. 2C can be formed by folding a single sheet of packaging material to form a tube, then bonding the edges to form bottom seam 52 at the bottom. The film can be cut and bonded to form each end (56, 58) (before or during placement of dough pieces inside of the package). Dough pieces 57 are shown in a multi-row, horizontally-stacked configuration.

Package 60 of FIG. 2D can be formed by folding a single sheet of packaging material to form a tube, then bonding the edges to form bottom seam 62 at the bottom. The film can be cut and bonded to form each end (66, 68) (before or during placement of dough pieces inside of the package). Dough pieces 67 are shown in a multi-row, horizontally-stacked configuration.

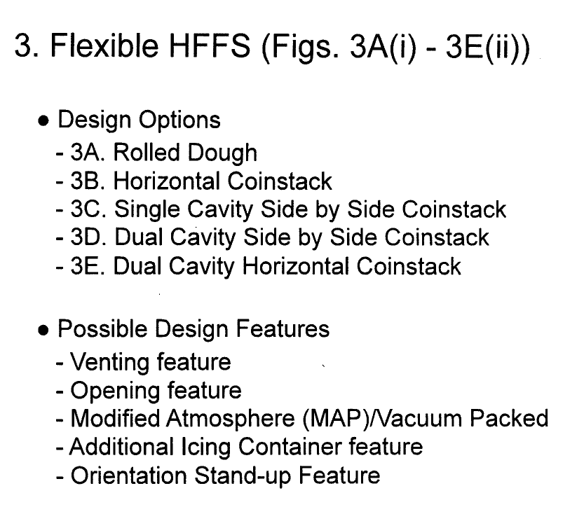

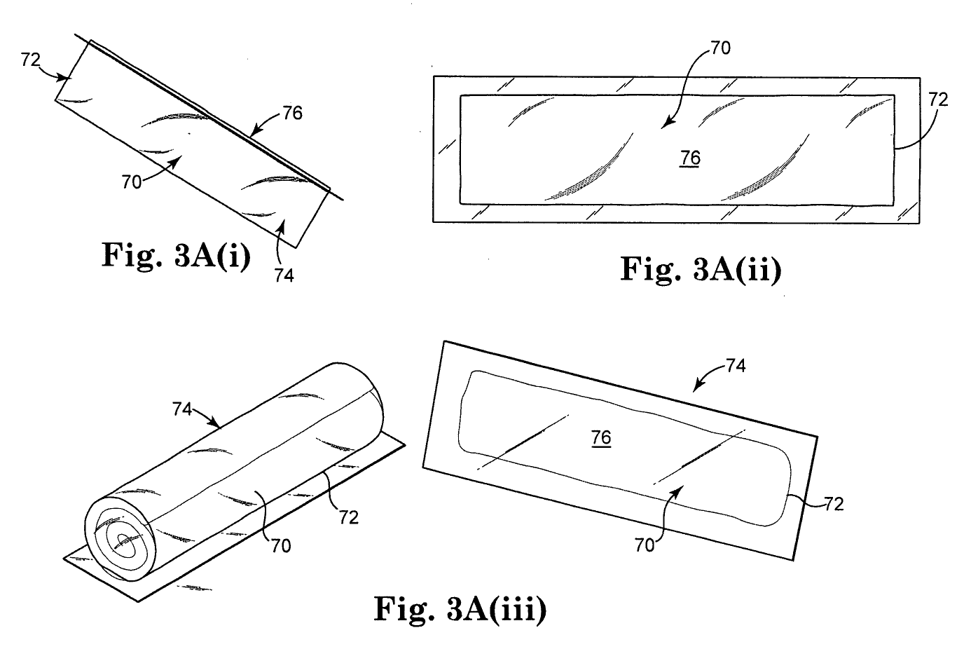

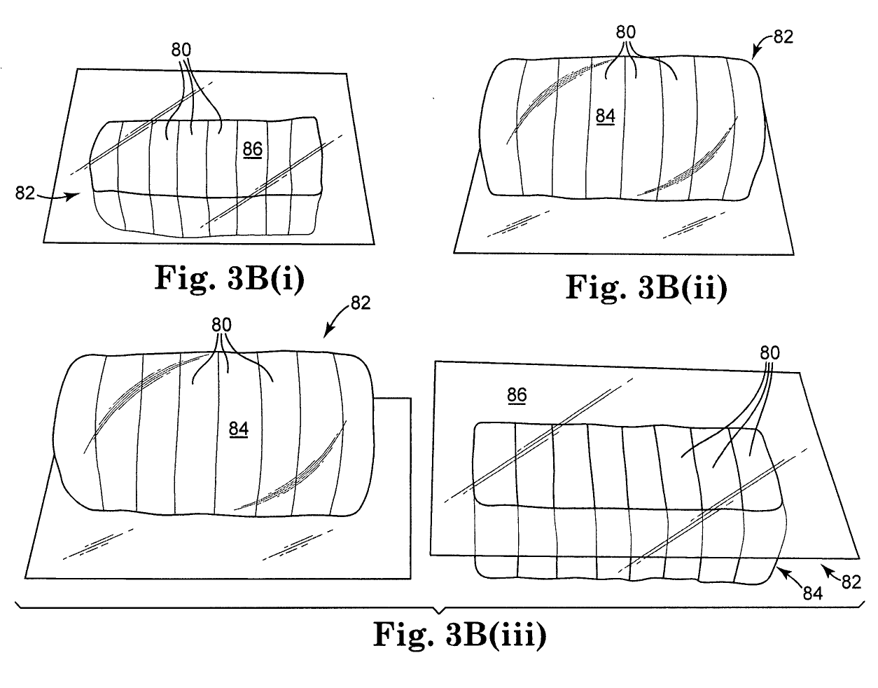

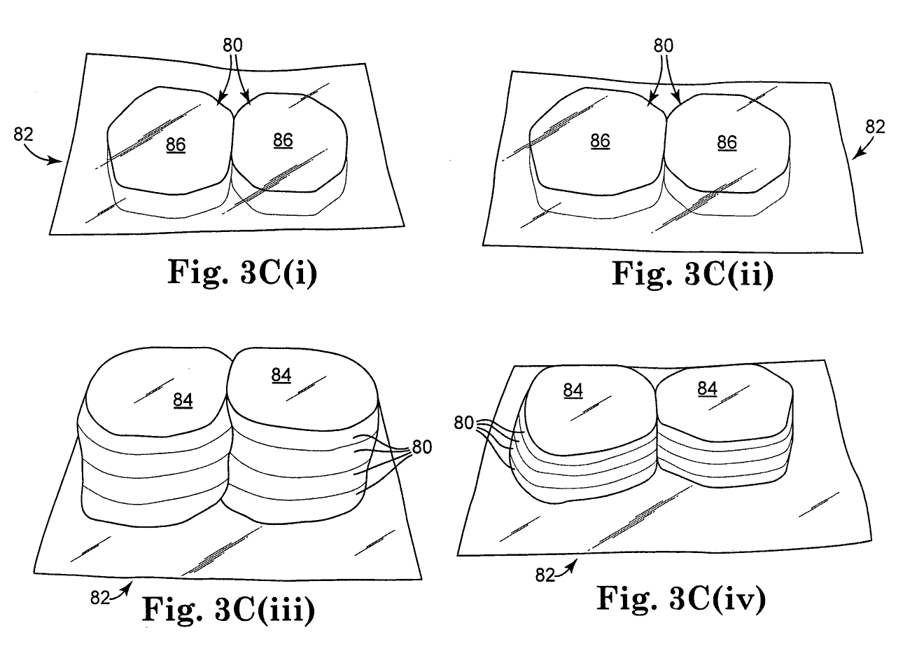

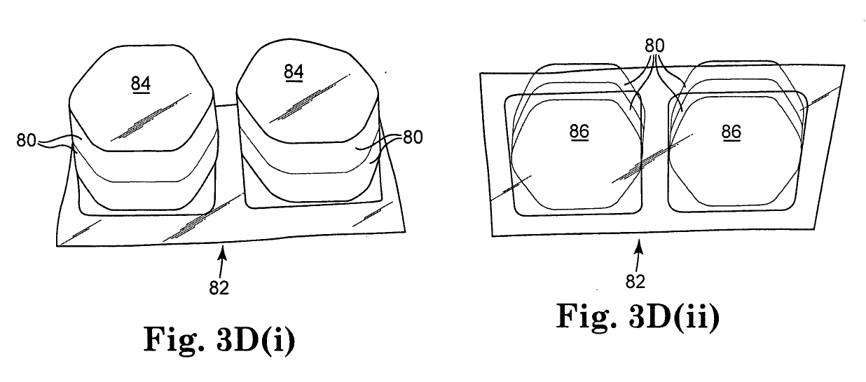

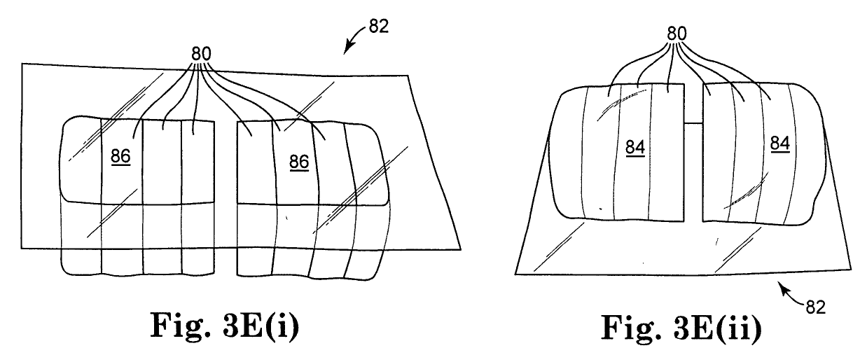

FIG. 3 and FIGS. 3Ai through 3Eii describe and illustrate options for package configurations prepared by horizontal form fill sealed (“HFFS”) packages. As stated, options include various stacking orientations for packaging multiple dough pieces. Venting and opening mechanisms can be any of those described herein (vents are not illustrated). The product can contain a dough at low pressure or at ambient pressure. Any of these packages can optionally contain a second package for a non-dough component of a packaged dough product.

FIGS. 3A(i), 3A(ii), and 3A(iii) illustrate a single piece rolled dough (70) contained in a two-piece horizontal form fill sealed package (72). A bottom piece (74) includes a single cavity into which a dough piece (70) is placed, and optionally also a non-dough component package (not shown). A top piece (76) is placed over the bottom piece and the package is sealed. The package is evacuated to include minimal headspace.

FIGS. 3B(i), 3B(ii), 3B(iii) show a similar horizontal form fill sealed package containing multiple dough packages in a single cavity, stacked in a “horizontal coinstack” configuration. The package is evacuated to include minimal headspace and can be at ambient or low pressure. As shown, multiple dough pieces (80) are contained in a two-piece horizontal form fill sealed package (82). A bottom piece (84) includes a single three-dimensional cavity into which dough pieces (80) are placed, and optionally also a non-dough component package (not shown). A top piece (86) is placed over the bottom piece (84) and the package is sealed.

FIGS. 3C(i), 3C(ii), 3C(iii), and 3C(iv) show a similar package in a “side-by-side coinstack” configuration, with the two stacks being contained within a single cavity of a bottom piece.

FIGS. 3D(i) and 3D(ii) show a similar package that includes two separate cavities in a bottom piece, sealed with a single top piece, with dough pieces present in each cavity and oriented in a “side-by-side coinstack” configuration. These figures illustrate a packaged dough product containing two three-dimensional cavities; more cavities may also be used. Also, each of the cavities in the illustrated package includes dough, yet a non dough component may be included along with a dough in a package or in a cavity.

FIGS. 3E(i) and 3E(ii) show a similar package that includes two cavities in a bottom piece, sealed with a single top piece, with dough pieces oriented in a “horizontal coinstack” configuration.

FIG. 8 illustrates a single cavity horizontal form fill and seal package (82) that includes a dough product (one or multiple pieces) (80) and a separate package (83) that includes a non-dough component, each in the same cavity of a bottom piece. As illustrated, the package for the non-dough component is a flexible envelope. A top piece (86) of package 82 seals both the dough component (80) and the non-dough component package (83) in the cavity of the bottom piece (84).

FIG. 9 illustrates a multiple-cavity horizontal form fill and seal package that includes a dough product (one or multiple pieces, not shown) in one cavity, and a non-dough component (85, not specifically shown) in a second cavity. A top piece (86) seals both the dough component and the non-dough component package in the two separate cavities of the bottom piece (84), keeping the dough component and the non-dough component separated during refrigerated or frozen storage.

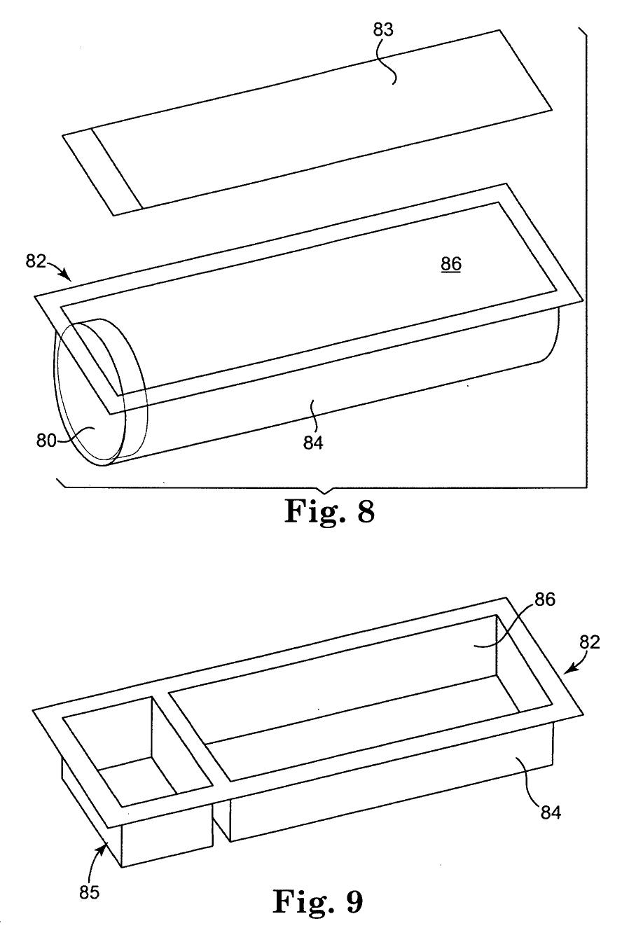

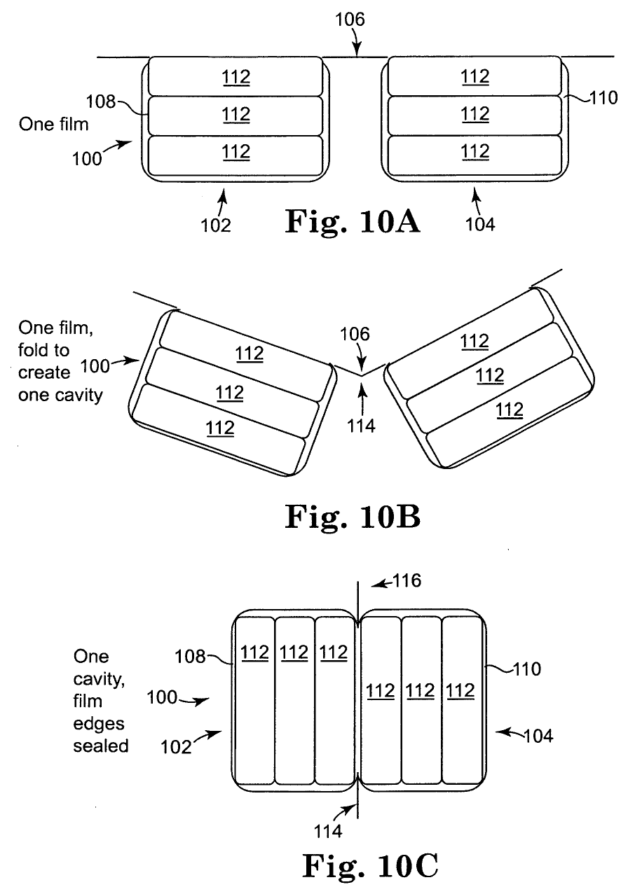

FIGS. 10A, 10B, and 10C illustrate a package that includes two opposing films, from a single piece of film, each of the two opposing films including a three-dimensional cavity. Referring to FIG. 10A, package 100 includes films 102 and 104 connected at line 106 (shown in one dimension), each including a cavity 108 and 110. Each cavity includes three stacked dough pieces 112. At FIGS. 10B and 10C, the two films are brought together by folding at line 106, into opposition, forming fold 114. Three edges that align around the perimeter of package 100 are sealed, including sealed edge 116, optionally with venting. Each cavity 108 and 110 is shown to include dough pieces. Alternately, a non-dough component can be included within a cavity in place of a single one of the illustrated dough pieces or in place of all dough pieces contained in one of the cavities.

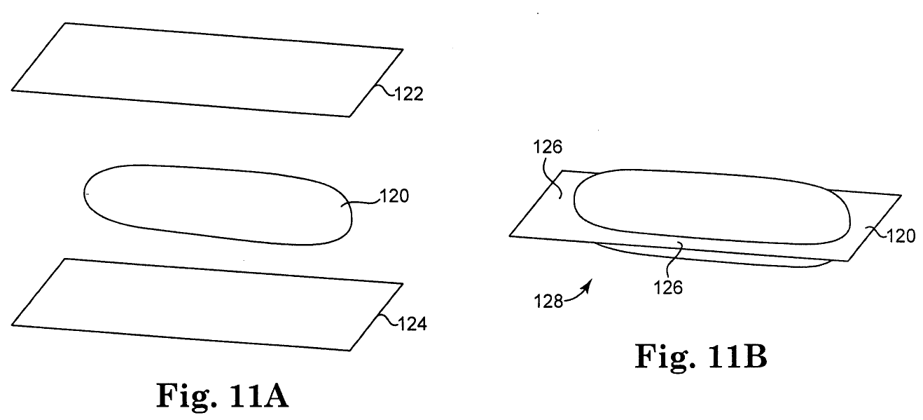

FIGS. 11A and 11C illustrate a package that includes two opposing films, from two separate pieces of film, each of the two opposing films being a flat film that does not including a three-dimensional cavity. Referring to FIG. 11A, opposing flat films 122 and 124 to contact dough piece 120. At FIG. 11B, the two films are brought together by surfaces of each film contacting dough piece 120 at a opposing sides of the dough piece (e.g., top and bottom sides). Edges 126 around the perimeter of package 128 are sealed, optionally with venting, to produce package 128 that contains dough piece 120 between the two separate pieces of flat film. Dough piece 120 is illustrated to be a single piece. Alternately, multiple dough pieces can be included in package 128, or as another alternative a non-dough component can be included in package 128 along with one or more dough piece.

Specific embodiments of the invention can included the following, as well as methods of preparing and using these packaged dough compositions.

A refrigerator stable, packaged, unproofed, partially proofed, or pre-proofed chemically leavened dough composition as described herein, optionally in a low pressure or ambient package, wherein the package comprises any one or a combination of the following:

a vent that comprises a tortuous path;

a horizontal form fill sealed package that contains one or multiple dough pieces stacked in either a horizontal or side-by-side configuration; a bottom piece of the flexible package can include one or multiple cavities sealed by a single top piece;

a flowrap package that contains one or multiple dough pieces stacked in either a horizontal or side-by-side configuration;

a package that contains a multi-layer flexible film having an opening mechanism formed by multiple cuts, partial cuts, or score-lines that penetrate one or multiple layers of the film but do not penetrate the film entirely; the film can include two score-lines on opposite surfaces that are adjacent to each other so that the film can be delaminated or partially delaminated at the portion of the multi-layer film between the opposite score-lines.

1-48. (canceled)

49. A packaged dough product comprising two opposing films, the films containing dough between opposing surfaces of the films and the films being sealed around a perimeter of the package.

50. The product of claim 49 wherein the package contains a separate package for a non-dough component.

51. The product of claim 49 wherein the package comprises a vent that comprises a tortuous path.

52. The product of claim 49 wherein the package contains multiple dough pieces, the pieces being in a stacked configuration.

53. The product of claim 49 wherein the package is an unvented low pressure package.

54. The package of claim 49 wherein the package interior is evacuated.

55. The package of claim 49 wherein the package interior is evacuated and remains at a low pressure during refrigerated storage of at least two weeks.

56. The product of claim 49 wherein the package comprises an opening mechanism comprising partial cuts on opposite sides of the multi-layer film, each partial cut penetrates one or multiple layers of the film but does not penetrate the film entirely.

57. The product of claim 49 wherein the two films are two separate film pieces.

58. The product of claim 57 wherein the package is an unvented low pressure package having a package interior that is evacuated.

59. The product of claim 49 wherein the two films are connected integrally at a folded edge.

60. The product of claim 59 wherein the package is an unvented low pressure package having a package interior that is evacuated.

61. The product of claim 49 wherein a film comprises a three-dimensional cavity.

62. The product of claim 61 wherein the package is an unvented low pressure package having a package interior that is evacuated.

63. The product of claim 49 wherein each of the two films comprises a three-dimensional cavity.

64. A method of packaging a dough within a package comprising two opposing films, the method comprising
providing a first film surface,
placing raw dough in contact with the first film surface,
providing a second film surface,
placing the second film surface in contact with the raw dough, and
closing the package by sealing edges of the films.

65. The method of claim 64 wherein the first film surface and the second film surface are part of the same piece of film, and the piece of film is folded.

66. The method of claim 64 wherein the first film surface and the second film surface are located on two separate pieces of film.

67. The method of claim 64 wherein the package comprises a vent at a seal, the vent comprising a tortuous path.

68. The method of claim 64 wherein a film comprises a three-dimensional cavity.
